(19) United States
(12) Patent Application Publication
(10) Pub. No.: US 2020/0381859 A1
(43) Pub. Date: Dec. 3, 2020

(54) ELECTRICAL CONNECTION TERMINAL AND MALE-FEMALE MATCHING TYPE ELECTRICAL CONNECTOR USING SAME

(71) Applicant: Xiamen GHGM Industrial Trade Co., Ltd., Xiamen City (CN)

(72) Inventors: Bingshui CHEN, Xiamen City (CN); Baohua HUANG, Xiamen City (CN); Zhihuan LI, Xiamen City (CN); Yonglong LI, Xiamen City (CN)

(21) Appl. No.: 16/503,086

(22) Filed: Jul. 3, 2019

(30) Foreign Application Priority Data
May 30, 2019 (CN) 201910462294.2

(51) Int. Cl. H01R 13/26; H01R 13/631; H01R 12/55

(52) U.S. Cl. CPC H01R 13/26; H01R 12/55; H01R 13/631

(57) ABSTRACT

The invention discloses an electrical connection terminal comprising a substrate, wherein an edge of the front end of the substrate is extended and folded to form an elastic piece, a convex contact is formed on the elastic piece, and an external connection part is formed at the rear end of the substrate. The invention further discloses a male-female matching type electrical connector using the electrical connection terminal, wherein at least one of two terminals to be connected is the electrical connection terminal. The structure is simple, elasticity is high, contacts are in close contact, electrical connection is more reliable, and production and assembly of products using the electrical connection terminal are facilitated.

### BACKGROUND OF THE INVENTION

### 1. Technical Field

The invention relates to the technical field of electrical connectors, in particular to a male-female matching type electrical connector using an electrical connection terminal.

### 2. Description of Related Art

In prior art, male and female terminals are electrically connected through wires, but this connection method is complex and has the defect of infirm connection. Or, the male terminals and the female terminals can be conveniently connected through male-female docking type connectors, as shown in FIG. 1 or FIG. 2. However, it can be found by analysis on the terminal structure that convex elastic contacts 110 and 210 are formed at the contact parts of the male terminal 100 and the female terminal 200, while the elastic contacts 110 and 120 are poor in contact tightness and electrical connection reliability due to their poor elasticity, and thus, need to be improved.

In view of this, the inventor specially developed a novel male-female matching type electrical connector in this application.

### BRIEF SUMMARY OF THE INVENTION

The objective of the invention is to provide an electrical connection terminal, and a male-female matching type electrical connector which uses the electrical connection terminal, has a simple structure, adopts a high-elasticity elastic piece, and achieves close contact of contacts and more reliable electrical connection.

The solution adopted by the invention is as follows:

An electrical connection terminal is provided with a substrate, wherein an edge of the front end of the substrate is extended and folded to form an elastic piece, a convex contact is formed on the folded elastic piece, and an external connection part is formed at the rear end of the substrate.

The folded elastic piece has a front section, a middle section and a rear section and protrudes in a form that the middle section is higher than the front section and the rear section, and a convex part serves as the contact of the elastic piece.

A side edge of the front end of the substrate is extended and laterally folded to form the elastic piece, and the front section and the rear section of the elastic piece incline downwards in a direction perpendicular to the lateral folding direction, so that the middle section of the elastic piece is higher than the front section and the rear section of the elastic piece.

The middle section of the elastic piece is planar, and the planar middle section is higher than the front and rear sections which incline downwards.

The middle section of the elastic piece is arc, and the arc middle section is higher than the front and rear sections which incline downwards.

A front edge of the front end of the substrate is extended and folded backwards to form the elastic piece, and the middle of the folded elastic piece protrudes in an arc shape or a planar shape.

The folded elastic piece has a front section and a rear section and protrudes in a form that the rear section is higher than the front section, a convex part serves as the contact of the elastic piece, and the rear section protrudes in an arc shape or a planar shape.

The external connection part is a wire contact elastic piece formed by bending the rear end of the substrate backwards and is to be electrically connected with an external wire.

The substrate is flat and straight, and the folded elastic piece and the backward-bent wire contact elastic piece are located on one side of the substrate.

The substrate is bent twice from the middle to form a Z shape, and the folded elastic piece and the backward-bent wire contact elastic piece are respectively located on two sides of the substrate.

The external connection part is a weld pin formed by bending the rear end of the substrate and is to be electrically connected with a PCB.

A barb used for installation positioning is formed on the substrate.

A male-female matching type electrical connector comprises a male terminal insulation shell and a female terminal insulation shell, wherein the male terminal insulation shell and the female terminal insulation shell are respectively provided with through cavities and each have an end provided with an insertion hole and an end provided with an external port, and the male terminal insulation shell and the female terminal insulation shell can move relative to each other to be jointed or separated via the insertion holes; at least one terminal is installed in the cavity of the male terminal insulation shell, at least one terminal is installed in the cavity of the female terminal insulation shell, and the terminals are provided with contacts which correspond to the insertion holes and are used for butt joint, and external connection parts which correspond to the external ports; wherein, at least one of the two terminals to be connected is the electrical connection terminal provided with the substrate, the edge of the front end of the substrate is extended and folded to form the elastic piece, the convex contact is formed on the folded elastic piece, and the external connection part is formed at the rear end of the substrate; and when the male terminal insulation shell and the female terminal insulation shell move to be jointed, the terminal contacts in the cavities of the male terminal insulation shell and the female terminal insulation shell are kept in close contact under the effect of the folded elastic piece.

The elastic piece of the electrical connection terminal has a front section, a middle section and a rear section and protrudes in a form that the middle section is higher than the front section and the rear section, and a convex part serves as the contact of the elastic piece; and when the male terminal insulation shell and the female terminal insulation shell move to be jointed, the contact of the electrical connection terminal keeps close contact with the other terminal at the highest middle section or at the rear section.

The folded elastic piece of the electrical connection terminal has a front section and a rear section and protrudes in a form that the rear section is higher than the front section, a convex part serve as the contact of the elastic piece, and the rear section protrudes in an arc shape or in a planar shape; and when the male terminal insulation shell and the female terminal insulation shell move to be jointed, the contact of the electrical connection terminal keeps close contact with the other terminal at the rear section.

The two terminals to be connected are both electrical connection terminals; and when the male terminal insulation shell and the female terminal insulation shell move to be jointed, the terminal contacts in the cavities of the male terminal insulation shell and the female terminal insulation shell keep in close contact under the effect of the two folded elastic pieces.

One of the two terminals to be connected is the electrical connection terminal, the other terminal is a common terminal, and the common terminal directly rises to form a contact used for butt joint.

Barbs are formed on the terminals and are matched with the inner walls of the corresponding cavities so as to fix the terminals in the cavities.

By adoption of the above solution, the structure is simple, and installation is convenient. The contact of the electrical connection terminal is formed on the folded elastic piece which has high elasticity, so that the contacts are kept in close contact, electrical connection is more reliable, and production and assembly of products using the electrical connection terminal are facilitated. In application, when the insertion holes of the male terminal insulation shell and the female terminal insulation shell are docked, and along with the relative movement of at least one folded elastic piece, the terminals to be connected are kept in sufficient and close contact under the effect of the folded elastic piece, so that reliable electrical connection of the male terminal and the female terminal is achieved.

The invention is further explained below with reference to accompanying drawings and embodiments.

### BRIEF DESCRIPTION OF THE SEVERAL VIEWS OF THE DRAWINGS

FIG. 1 and FIG. 2 are structural views of two existing male-female docking type electrical connectors;

FIG. 3 and FIG. 4 are respectively an assembled sectional view and an exploded view of an electrical connection terminal applied to a male-female matching type electrical connector in Embodiment 1 of the invention;

FIG. 5A and FIG. 5B are respectively a perspective view and a side view of the electrical connection terminal in one form in Embodiment 1 of the invention;

FIG. 6A and FIG. 6B are respectively a perspective view and a side view of the electrical connection terminal in another form in Embodiment 1 of the invention;

FIG. 7 and FIG. 8 are respectively an assembled view and an exploded view of the electrical connection terminal applied to the male-female matching type electrical connector in Embodiment 2 of the invention;

FIG. 9A and FIG. 9B are respectively a perspective view and a side view of the electrical connection terminal in one form in Embodiment 2 of the invention;

FIG. 10A, FIG. 10B, FIG. 11A, and FIG. 11B are respectively perspective views and side views of the electrical connection terminal in another form in Embodiment 2 of the invention;

FIG. 12A to FIG. 12C are three terminal matching forms of the invention.

### REFERENCE SIGNS

100, male terminal; 200, female terminal; 110 and 210, elastic contact;
1, electrical connection terminal; 11, substrate; 12, elastic piece; 13, contact; 14, external connection part; 15, barb;
2, male terminal insulation shell; 21, cavity; 22, insertion hole; 23, external port;
3, female terminal insulation shell; 31, cavity; 32, insertion hole; 33, external port;
4, wire.

### DETAILED DESCRIPTION OF THE INVENTION

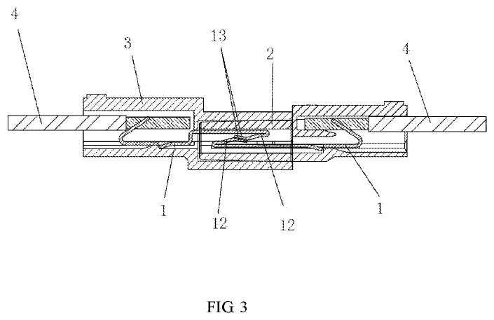

As shown in FIG. 3 to FIG. 12C, the invention discloses an electrical connection terminal 1 and a male-female matching type electrical connector using the same.

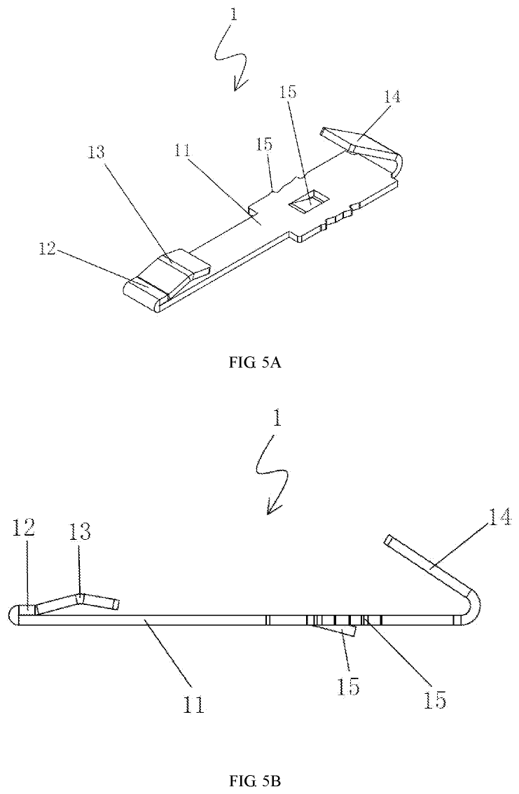

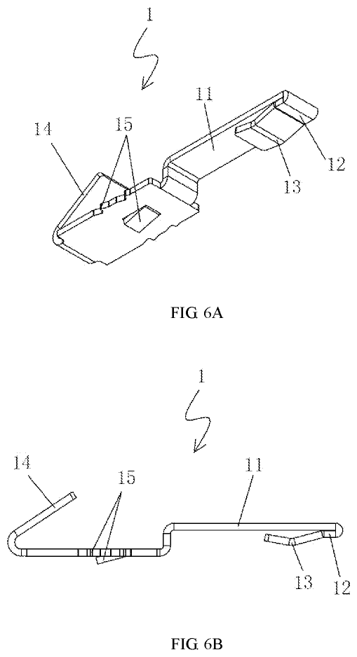

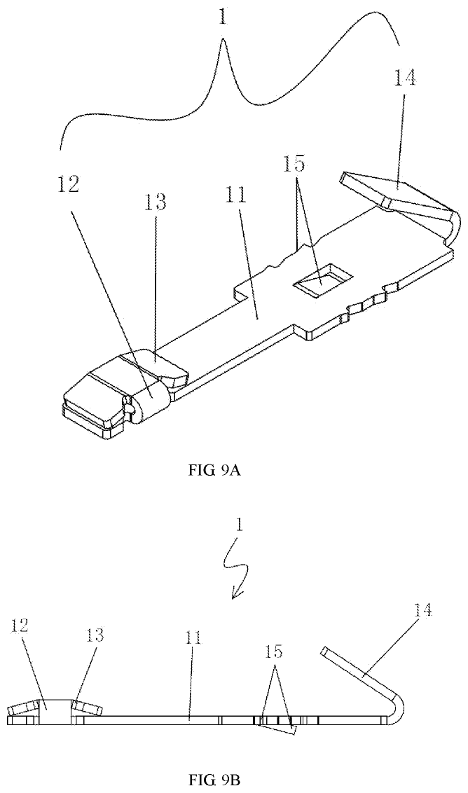

As shown in FIG. 5A, FIG. 5B, FIG. 6A, FIG. 6B, and FIG. 9A to FIG. 11B, the electrical connection terminal 1 comprises a substrate 11. An edge of the front end of the substrate 11 is extended and folded to form an elastic piece 12. A convex contact 13 is formed on the folded elastic piece 12. An external connection part 14 is formed at the rear end of the substrate 11.

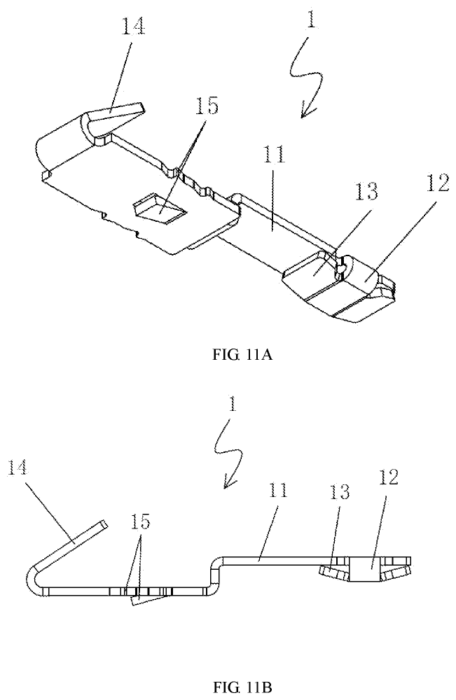

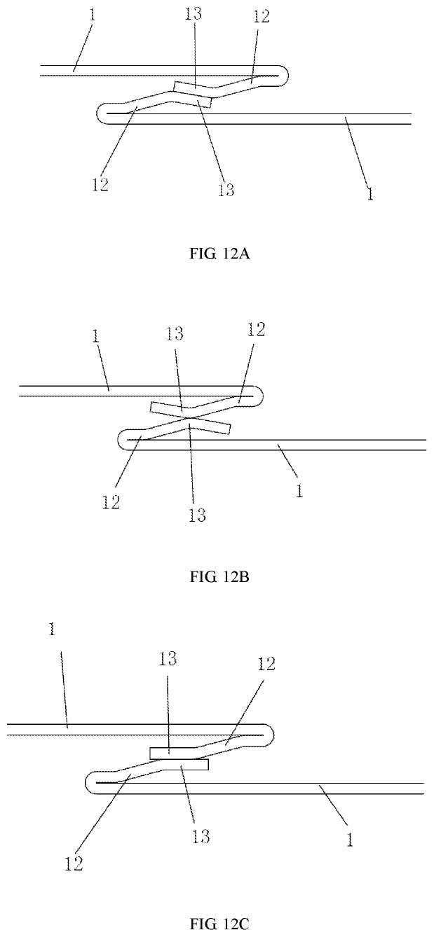

It should be pointed out that the elastic piece 12 can protrude in various forms. For instance, the folded elastic piece 12 has a front section, a middle section and a rear section and protrudes in such a form that the middle section is higher than the front section and the rear section, the convex part serves as the contact 13 of the elastic piece 12, and due to the height differences between the middle section and the front and rear sections, the elastic piece 12 is in the convex form; the elastic piece 12 protrudes in an arc form, a planar form, or other forms. The contact 13 formed by the convex part is used for butt joint of a male terminal and a female terminal matched with the male terminal; and in actual use, the contact 13 keeps close contact with another terminal at the highest middle section (as shown in FIG. 12B) or at the rear section (as shown in FIG. 12A). Or, the folded elastic piece 12 has a front section and a rear section and protrudes in such a form that the rear section is higher than the front section, the convex part serves as the contact 13 of the elastic piece 12, and due to the fact that the rear section is higher than the front section, the elastic piece 12 is in the convex form; the rear section protrudes in an arc form, a planar form, or other forms, and the contact 13 formed by the convex part is used for butt joint of a male terminal and a female terminal matched with the male terminal; and in actual use, the contact 13 keeps close contact with another terminal at the rear section (as shown in FIG. 12C).

Wherein, in Embodiment 1 shown by FIG. 5A, FIG. 5B, FIG. 6A and FIG. 6B, a front edge of the front end of the substrate 11 is extended and is folded back to form the elastic piece 12, and the middle of the folded elastic piece 12 protrudes in an arc form (as shown in FIG. 5A and FIG. 6A) or in a planar form to form the contact 13.

In Embodiment 2 shown by FIG. 9A to FIG. 11B, a side edge of the front end of the substrate 11 is extended and is laterally folded to form the elastic piece 12, the front section and the rear section of the elastic piece 12 incline downwards in a direction perpendicular to the lateral folding direction, so that the elastic piece 12 protrudes in such a form that the middle section is higher than the front section and the rear section. Particularly, as shown in FIG. 9A to FIG. 11B, the middle section of the elastic piece 12 is planar, and the planar middle section is higher than the front and rear sections inclining downwards. The middle section of the elastic piece 12 can also be arc (as shown in FIG. 5A and FIG. 6A), and the arc middle section is higher than the front and rear sections inclining downwards.

In Embodiment 1 and Embodiment 2 of the invention, the external connection part 14 is a wire contact elastic piece which is formed by bending the rear end of the substrate 11 backwards and is to be electrically connected with an external wire 4. In order to adapt to different products, the external connection part 14 can also be a weld pin which is formed by bending the rear end of the substrate 11 and is to be electrically connected with an external PCB.

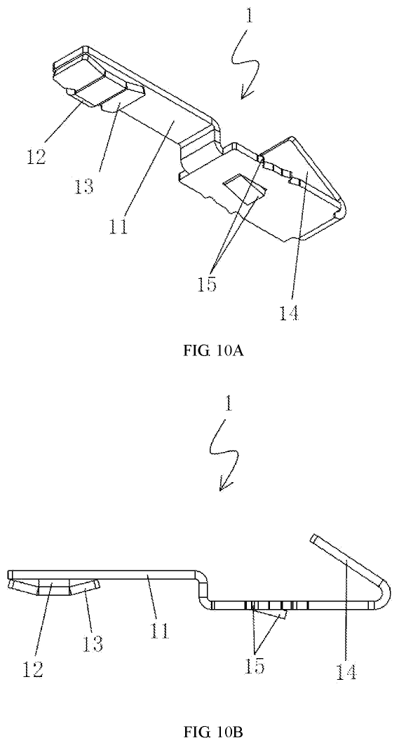

In addition, in order to facilitate assembly, to improve the recognizability during assembly, and to fulfill a fool-proof function, the substrate 11 is flat and straight as shown in FIG. 5A and FIG. 9A, the folded elastic piece 12 and the backward-bent wire contact elastic piece (external connection part 14) are located on one side of the substrate 11, and this structure of the invention is assembled in a male terminal. As shown in FIG. 6A, FIG. 10A and FIG. 11A, the substrate 11 is folded twice from the middle to form a Z shape, the folded elastic piece 12 and the backward-bent wire contact elastic piece (external connection part 14) are respectively located on two sides of the substrate 11, and this structure is assembled in a female terminal. In this way, different terminals can be recognized and can be rapidly assembled in corresponding insulation shells, electrical connection is facilitated, and assembly is more convenient.

The electrical connection terminal 1 is further provided with a barb 15 formed on the substrate 11 and used for installation positioning.

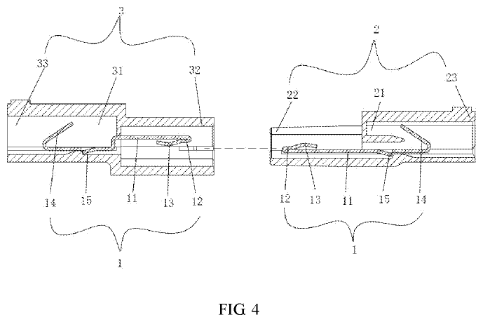

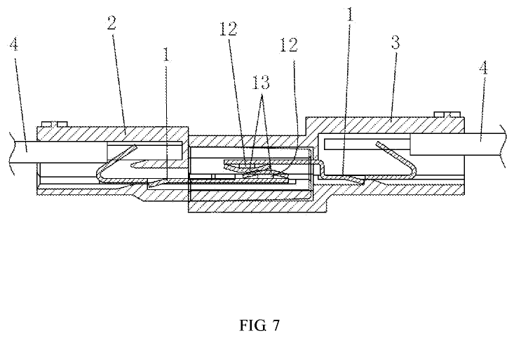

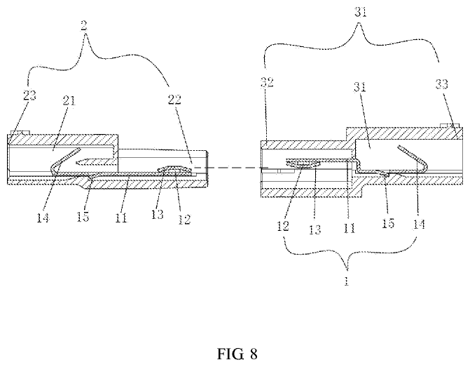

As shown in FIG. 3, FIG. 4, FIG. 7 and FIG. 8, the electrical connection terminal is applied to a male-female matching type electrical connector. The male-female matching type electrical connector comprises a male terminal insulation shell 2 and a female terminal insulation shell 3, wherein the male terminal insulation shell 2 and the female terminal insulation shell 3 are respectively provided with a through cavity 21 and a through cavity 31. Insertion holes 22 and 32 are formed in ends (close to each other) of the male terminal insulation shell 22 and the female insulation shell 3, and external ports 23 and 33 are formed in ends (away from each other) of the male terminal insulation shell 2 and the female terminal insulation shell 3.

The male terminal insulation shell 2 and the female terminal insulation shell 3 can move relative to each other to be jointed via the insertion holes 22 and 32 to achieve electrical connection or to be separated to cut off electrical connection.

At least one terminal is installed in the cavity 21 of the male terminal insulation shell 2, and at least one terminal is installed in the cavity 31 of the female terminal insulation shell 3. The terminals are provided with contacts which correspond to the insertion holes 22 and 32 and are used for realizing electrical connection, as well as external connection parts which correspond to the external ports 23 and 33 and are to be electrically connected with an external wire 4 or an external PCB.

The key of the invention lies in that: at least one of the two terminals to be connected is the electrical connection terminal 1 which is provided with a substrate 11, wherein an edge of the front end of the substrate 11 is extended and folded to form an elastic piece 12, a convex contact 13 is formed on the folded elastic piece 12, an external connection part 14 is formed at the rear end of the substrate 11, and the detailed structure of the electrical connection terminal 1 is as aforesaid. In this way, when the male terminal insulation shell 2 and the female terminal insulation shell 3 move to be jointed, the terminal contacts in the corresponding cavities 21 and 31 of the male terminal insulation shell 2 and the female terminal insulation shell 3 can be kept in close contact under the effect of the folded elastic piece 12.

Preferably, in Embodiment 1 and Embodiment 2, the two terminals to be connected are both electrical connection terminals 1, so that when the male terminal insulation shell 2 and the female terminal insulation sell 3 move to be jointed (the insertion holes 22 and 32 are docked), the elastic pieces 12 move relatively to each other, the contacts 13 of the elastic pieces 12 start to draw close to each other, then abut against and overlap with each other, and finally, are staggered and attached to each other, and afterwards, the contacts 13 of the two terminals 1 in the male terminal insulation shell 2 and the female insulation shell 3 are kept in more sufficient and closer contact at the rear section (as shown in FIG. 12A) under the strong elastic effect of the two folded elastic pieces 12, so that electrical connection is more reliably, and production and assembly of the male-female matching type electrical connector using the electrical connection terminal are greatly facilitated.

As for electric connection terminals 1 in different forms, the contacts 13 can be electrically connected in different manners. As shown in FIG. 12B, the two terminals to be connected are both electrical connection terminals 1, so that when the male terminal insulation shell 2 and the female terminal insulation shell 3 move to be jointed (the insertion holes 22 and 32 are docked), the elastic pieces 12 move relative to each other, the contacts 13 of the elastic pieces 12 start to draw close to each other, then abut against and overlap with each other, and finally, are staggered and attached to each other, and afterwards, the contacts 13 of the two terminals 1 in the male terminal insulation shell 2 and the female insulation shell 3 are kept in more sufficient and closer contact at the highest middle section (as shown in FIG. 12A) under the strong elastic effect of the two folded elastic pieces 12. As shown in FIG. 12C, the two terminals to be connected are both electrical connection terminals 1, so that when the male terminal insulation shell 2 and the female terminal insulation shell 3 move to be jointed (the insertion holes 22 and 32 are docked), the contacts 13 of the elastic pieces 12 start to draw close to each other, then abut against and overlap with each other, and finally, are staggered and attached to each other, and afterwards, the contacts 13 of the two terminals 1 in the male terminal insulation shell 2 and the female insulation shell 3 are kept in more sufficient and closer contact at the rear planar section (as shown in FIG. 12C) under the strong elastic effect of the two folded elastic pieces 12.

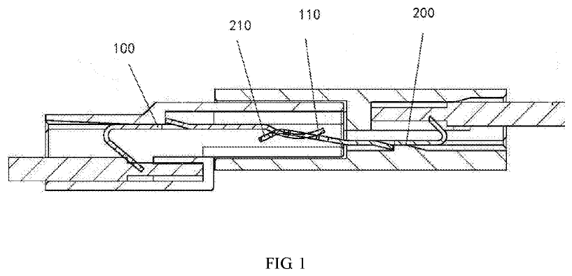

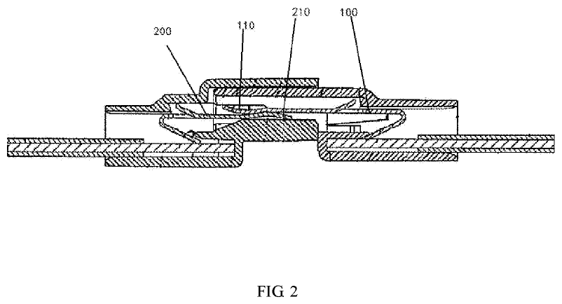

Or, one of the two terminals to be connected is the electrical connection terminal 1, while the other terminal is a common terminal (as shown in FIG. 1 and FIG. 2, or other structures), wherein the common terminal directly rises to form a contact used for butt joint. In this case, reliable electrical connection superior to that in the prior art (shown in FIG. 1 and FIG. 2) can also be realized by means of the high elasticity of the folded elastic piece 12 of the electrical connection terminal 1.

In order to fix the electrical connection terminals 1 to the male terminal insulation shell 2 and the female terminal insulation shell 3, barbs 15 matched with inner walls of the corresponding cavities 21 and 31 are further formed on the electrical connection terminals 1, and the electrical connection terminals 1 are fixed in the cavities 21 and 31 through the barbs 15.

The above embodiments are only specific ones of the invention, and are not intended to limit the protection scope of the invention. All equivalent changes achieved based on the design idea of the solution should also fall within the protection scope of the invention.

1. An electrical connection terminal, comprising:
a substrate, wherein an edge of a front end of the substrate is extended and folded to form an elastic piece, the elastic piece comprising:
a front section;
a rear section; and
a middle section, the middle section being higher than the front section and the rear section;
a convex contact formed on the middle section of the folded elastic piece; and
an external connection part is-formed at a rear end of the substrate.

2. The electrical connection terminal according to claim 1, wherein the convex contact serves as a contact of the elastic piece.

3. The electrical connection terminal according to claim 2, wherein a side edge of the front end of the substrate is extended and laterally folded to form the elastic piece, and the front section and the rear section of the elastic piece incline downwards in a direction perpendicular to the lateral folding direction, so that the middle section of the elastic piece is higher than the front section and the rear section of the elastic piece.

4. The electrical connection terminal according to claim 3, wherein the middle section of the elastic piece is planar, and the planar middle section is higher than the front and rear sections which incline downwards.

5. The electrical connection terminal according to claim 3, wherein the middle section of the elastic piece is arc, and the arc middle section is higher than the front and rear sections which incline downwards.

6. The electrical connection terminal according to claim 2, wherein a front edge of the front end of the substrate is extended and folded backwards to form the elastic piece, and a middle of the folded elastic piece protrudes in an arc shape or a planar shape.

7. The electrical connection terminal according to claim 1, wherein the rear section protrudes in an arc shape or a planar shape.

8. The electrical connection terminal according to claim 1, wherein the external connection part is a wire contact elastic piece formed by bending the rear end of the substrate backwards and is to be electrically connected with an external wire.

9. The electrical connection terminal according to claim 8, wherein the substrate is flat and straight, and the folded elastic piece and the backward-bent wire contact elastic piece are located on one side of the substrate.

10. The electrical connection terminal according to claim 8, wherein the substrate is bent twice from a middle to form a Z shape, and the folded elastic piece and the backward-bent wire contact elastic piece are respectively located on two sides of the substrate.

11. The electrical connection terminal according to claim 1, wherein the external connection part is a weld pin formed by bending the rear end of the substrate and is to be electrically connected with a PCB.

12. The electrical connection terminal according to claim 1, wherein a barb used for installation positioning is formed on the substrate.

13. A male-female matching type electrical connector, comprising a male terminal insulation shell and a female terminal insulation shell, wherein the male terminal insulation shell and the female terminal insulation shell are respectively provided with through cavities and each have an end provided with an insertion hole and an end provided with an external port, and the male terminal insulation shell and the female terminal insulation shell can move relative to each other to be jointed or separated via the insertion holes; at least one terminal is installed in the cavity of the male terminal insulation shell, at least one terminal is installed in the cavity of the female terminal insulation shell, and the terminals are provided with contacts which correspond to the insertion holes and are used for butt joint, and external connection parts which correspond to the external ports; wherein, at least one of the two terminals to be connected is the electrical connection terminal provided with the substrate according to claim 1, the edge of the front end of the substrate is extended and folded to form the elastic piece, the convex contact is formed on the folded elastic piece, and the external connection part is formed at the rear end of the substrate; and when the male terminal insulation shell and the female terminal insulation shell move to be jointed, the terminal contacts in the cavities of the male terminal insulation shell and the female terminal insulation shell are kept in close contact under the effect of the folded elastic piece.

14. The male-female matching type electrical connector according to claim 13, wherein when the male terminal insulation shell and the female terminal insulation shell move to be jointed, the contact of the electrical connection terminal keeps close contact with the other terminal at the highest middle section or at the rear section.

15. The male-female matching type electrical connector according to claim 13, wherein the rear section of the elastic piece of the electrical connection terminal protrudes in an arc shape or in a planar shape; and when the male terminal insulation shell and the female terminal insulation shell move to be jointed, the contact of the electrical connection terminal keeps close contact with the other terminal at the rear section.

16. The male-female matching type electrical connector according to claim 13, wherein the two terminals to be connected are both the electrical connection terminals; and when the male terminal insulation shell and the female terminal insulation shell move to be jointed, the terminal contacts in the cavities of the male terminal insulation shell and the female terminal insulation shell keep in close contact under the effect of the two folded elastic pieces.

17. The male-female matching type electrical connector according to claim 13, wherein one of the two terminals to be connected is the electrical connection terminal, the other terminal is a common terminal, and the common terminal directly rises to form a contact used for butt joint.

18. The male-female matching type electrical connector according to claim 13, wherein barbs are formed on the terminals and are matched with inner walls of the corresponding cavities so as to fix the terminals in the cavities.

19. The electrical connection terminal according to claim 1, wherein the convex contact serves as a mutual contact during electrical connection.
